(19) United States
(12) Patent Application Publication
(10) Pub. No.: US 2007/0064657 A1
(43) Pub. Date: Mar. 22, 2007

(54) Variable length physical random access channel frame structure and realization

(75) Inventors: Tao Wu, Eastwood (AU); Ling Lv, Shanghai (CN)

Correspondence Address: PERKINS COIE LLP;PATENT-SEA, P.O. BOX 1247, SEATTLE, WA, 98111-1247, US

(73) Assignee: Spreadtrum Communications Corporation, Sunnyvale, CA (US)

(21) Appl. No.: 11/525,255

(22) Filed: Sep. 20, 2006

(30) Foreign Application Priority Data
Sep. 20, 2005 (CN) 200510029799.8

(51) Int. Cl. H04B 7/216

(52) U.S. Cl. 370/335

(57) ABSTRACT

New PRACH frame structures and methods for implementing such structures for use in mobile communication systems are disclosed. The PRACH frame structures can include a variable-length message portion.

### CROSS-REFERENCE TO RELATED APPLICATION(S)

This application claims priority to Chinese Patent Application No. 200510029799.8 filed on Sep. 20, 2005, the disclosure of which is incorporated herein by reference in its entirety.

### TECHNICAL FIELD

The present disclosure relates to call setup methods and procedures in mobile communication systems. In particular, the present disclosure relates to a variable-length Physical Random Access Channel (PRACH) frame structure and realization for accommodating different service demands.

### BACKGROUND

A call setup process in a conventional 3G system is depicted in FIG. 1 and FIG. 2, using a first User Equipment (UE) calling a second UE as an example. As illustrated in these figures, the conventional 3G system incorporates several main functional entities including User Equipment (UE), NodeB, Radio Network Controller (RNC), and Core Network (CN). In the illustrated figures, it is assumed that a user initiates a Push to talk Over Cellular (PoC) service in the Packet Service (PS) domain, and Radio Resource Control (RRC) connection is built on a Dedicated Channel (DCH).

For the originating UE, the call setup process usually includes the following steps: (1) RRC connection setup; (2) Non-access Stratum (NAS) signaling setup and NAS signaling interaction; and (3) Radio Access Bearer (RAB) setup. For the receiving UE, the call setup process is similar to that of the originating UE and includes the following steps: (1) paging; (2) RRC connection setup; (3) Non-access Stratum (NAS) signaling setup and NAS signaling interaction; and (4) Radio Access Bearer (RAB) setup.

The purpose for establishing the RRC connection is to establish a dedicated signaling channel between the UE and the UTRAN (Universal Terrestrial Radio Access Network, typically including several RNC and NodeB) to transmit signals between the UE and the network and between the UE and the CN.

In communication systems, the duration of the call setup (or call setup delay) is a major factor affecting the quality of service. In some systems, such as in interaction games, emergent voice calls, Push to talk Over Cellular (PoC), which are sensitive to the duration delay, the call setup delay is relatively long in current systems (usually 6 to 10 seconds).

In order to reduce the call setup delay, the message sent from the UE to the network during the RRC connection setup may need to be increased. For example, more information (such as traffic type) can be transmitted to realize faster access during the RRC connection procedure. Thus, more bits need to be sent via the Random Access Channel (RACH) for the transmission of the RRC connection request. For a physical layer, the RACH is sent via the Physical Random Access Channel (PRACH). Therefore, a new PRACH frame structure is required to meet such a demand.

In Wideband Code Division Multiple Access (WCDMA) systems, the PRACH frame structure is represented as in FIG. 3. As illustrated, after the access Preamble, there is 10 ms or 20 ms to transmit the RRC connection request. In Time Division-Synchronized Code Division Multiple Access (TD-SCDMA) systems, the PRACH is similar to the frame structure of the DCH, as depicted in FIG. 4. The PRACH message portion length is 5 ms, 10 ms, or 20 ms. Thus, in all these systems, the maximum message length value of the PRACH can be too small to transmit a large amount of information.

The fixed-length PRACH message structure has several disadvantages. For example, if the preset PRACH message length is too small, a large amount of information cannot be transmitted to achieve faster access connection. On the other hand, if the pre-set PRACH message length is too large, the excess capacity becomes a waste for the UE, which may only need to transmit a small amount of information.

### BRIEF DESCRIPTION OF THE DRAWINGS

FIG. 1 is a flow chart of a call setup process at an originating end in accordance with the prior art.

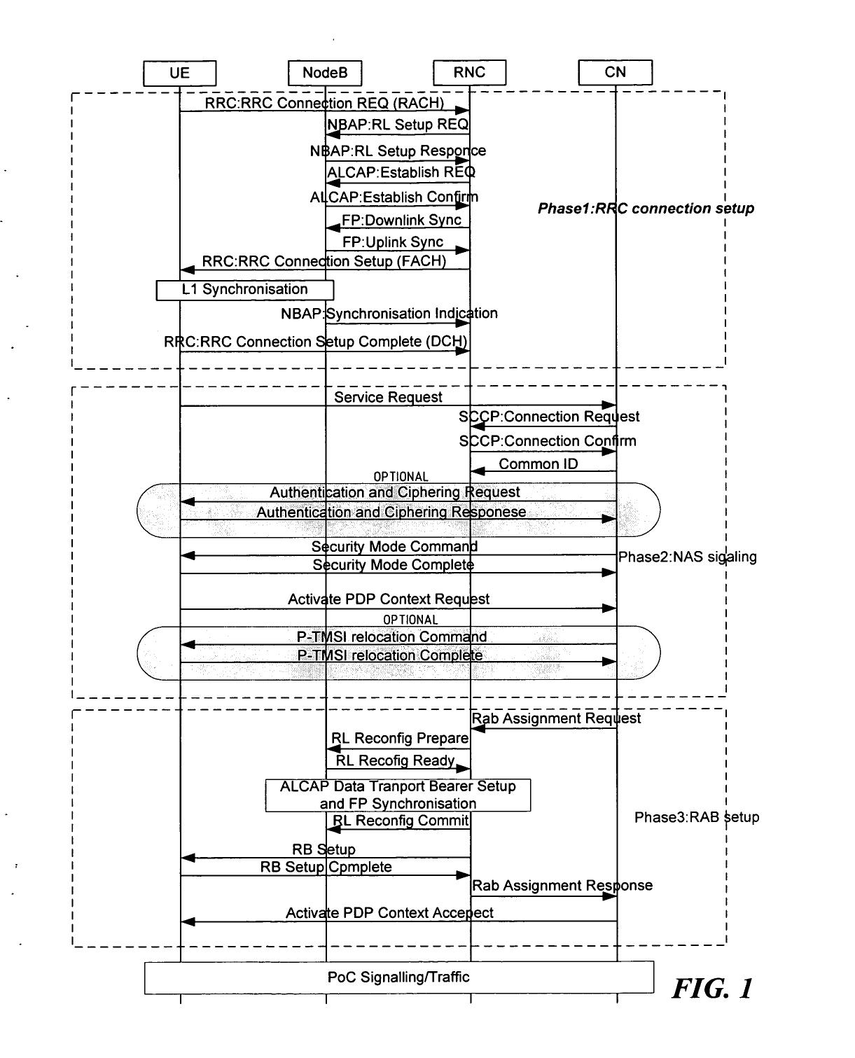

FIG. 2 is a flow chart of a call setup process at a receiving end in accordance with the prior art.

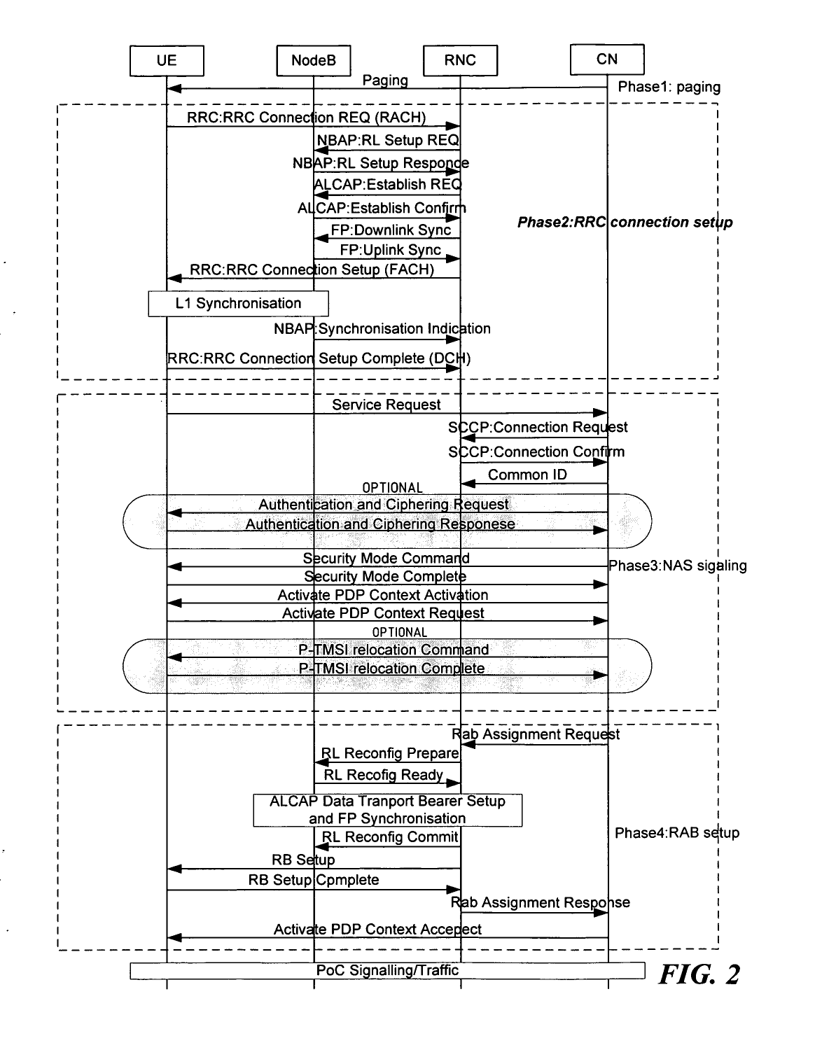

FIG. 3 is a PRACH frame structure in a WCDMA system in accordance with the prior art.

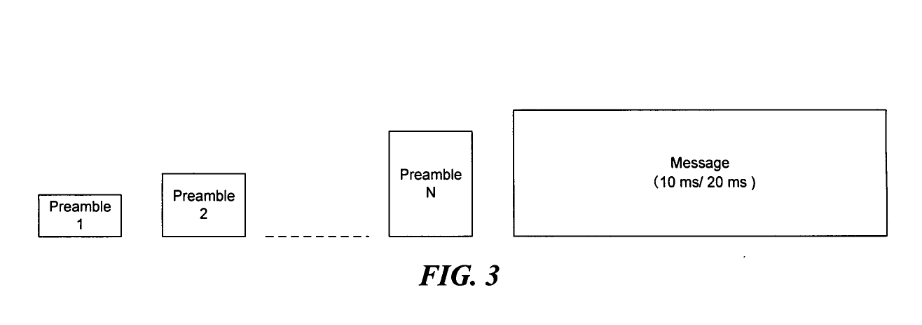

FIG. 4 is a PRACH frame structure in a TD-SCDMA system in accordance with the prior art.

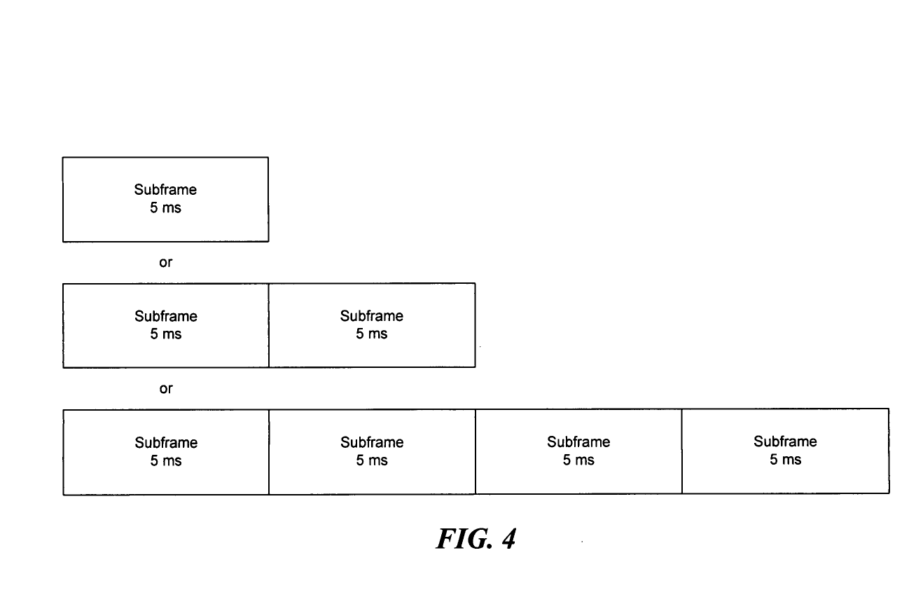

FIG. 5 is a variable-length PRACH frame structure in a WCDMA system in accordance with an embodiment of the present invention.

FIG. 6 is a variable-length PRACH frame structure in a TD-SCDMA system in accordance with another embodiment of the present invention.

### DETAIL DESCRIPTIONS

One aspect of the present invention relates to a variable-length PRACH frame structure that can be utilized in mobile communication systems. The variable-length PRACH frame structure includes a message portion that can have different message length for different services. In WCDMA systems, the PRACH message portion length can be prolonged from 1 to N sub-frames (N≧1), with the length of each sub-frame being 10 ms or 20 ms. In TD-SCDMA systems, the PRACH message portion length can be prolonged from 1 to N sub-frames (N≧1), with the length of each sub-frame being 5 ms. Another aspect of the present invention relates to a method of implementing the variable-length PRACH frame structure described above.

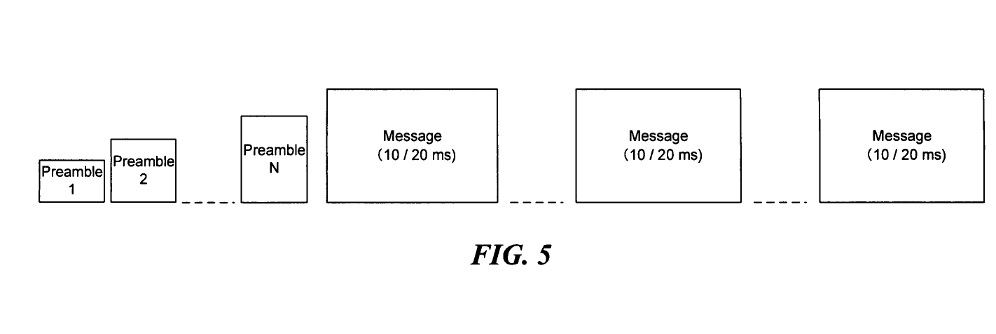

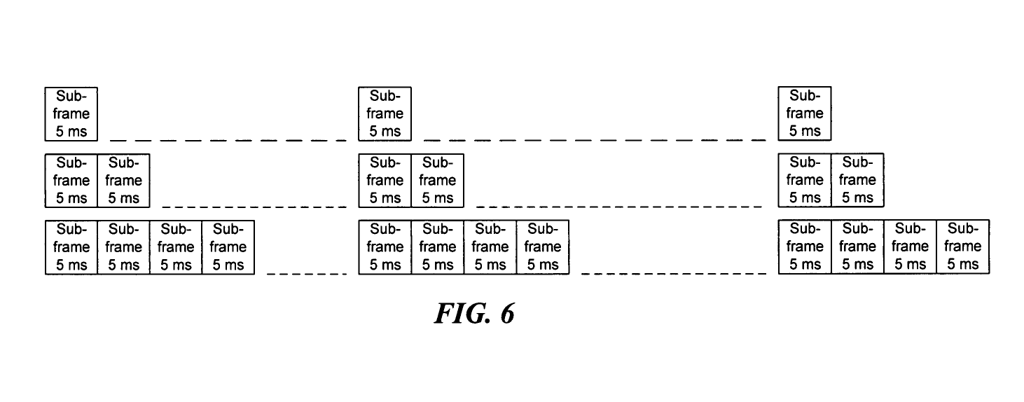

In one embodiment, a variable-length PRACH frame structure can include a message portion that can have different message length for different services. As illustrated in FIG. 5, In WCDMA systems, the PRACH message portion length is prolonged from 1 to N sub-frames (N≧1), with the length of each sub-frame being 10 ms or 20 ms. As illustrated in FIG. 6, in the TD-SCDMA systems, the PRACH message portion length is prolonged from 1 to N sub-frames (N≧1), with the length of each sub-frame being 5 ms.

A method of implementing the variable-length PRACH frame structure can include the following steps:

Step 1: determining a number of message bits (Nmax) within the maximum allowable Transmission Time Interval (TTI) of a PRACH message based on cell traffic and coverage.

Step 2: broadcasting the configuration determined in step 1 in the cell via a system broadcast channel.

Step 3: reading the system broadcast with a mobile station (e.g., a UE) and obtaining the number of the message bits within the maximum TTI.

Step 4: When access is necessary, the mobile station initiates a call setup procedure. If access is allowed, the mobile station will encode, multiplex and modulate the original message bits according to the broadcasted number of the message bits, and send the PRACH signals to a base station. The process can be further delineated into the following steps:

4.1 according to current service condition, generating the original message for PRACH transmission. The original message has a length M;

4.2 calculating a required number of TTI for transmission, NTTI=min (n|Nmax nΔM);

4.3 allocating the M message bits to the N_{TTI} transmission blocks as evenly as possible;

4.4 independently encoding the N_{TTI} transmission blocks;

4.5 when access is necessary, the mobile station initiates a call setup procedure to obtain an access allowance indication.

4.6 In continuous periods allowed for transmission, sequentially modulating and transmitting the N_{TTI} transmission blocks;

4.7 transmitting the N_{TTI} message in access preambles or access message portions, and notifying the network;

Step 5: the network demodulates the continuous N_{TTI} transmission blocks according to the obtained N_{TTI} message, combines the message bits into a complete message, and transmit the combined message to the RNC and the CN;

Step 6: RNC and CN completes the access procedures.

The following description uses a WCDMA system as an example to illustrate an embodiment of the present invention. In the illustrated embodiment, on the network side, a number of message bit (Nmax) within the maximum allowable Transmission Time Interval (TTI) of a PRACH message is determined based on the system network planning, the cell traffic type, and the Radio Resource Management (RRM) algorithm. The network then broadcasts system messages including the maximum length of each TTI in the PRACH message portion via the system BCH.

On the UE side, after power is on and a cell search is completed, a UE can receive and demodulates the system messages broadcasted via the BCH to obtain the maximum length of each TTI in the PRACH message portion. According to current service condition, the UE can generate an original message for the PRACH transmission having a length M. The UE can then calculate a required number of TTI for transmission, NTTI=min (n|Nmax n≧M) and allocate the M message bits to N_{TTI} transmission blocks as evenly as possible. The number of bits in each block is calculated as b=max (k|k≦M/n, kεN). The number of long blocks is calculated as: c=M−b·N_{TTI}. The number of transmission blocks in the first TTI is calculated as:

$${n}_{l} = \{ \begin{matrix}b + 1 & l \leq c \\ b & c < l \leq {N}_{TTI}\end{matrix} .$$

The transmission bits in the first TTI is calculated as:

$$[ \begin{matrix}{\sum }_{i = 1}^{{x}_{l - 1}} {n}_{i} + 1 & {\sum }_{i = 1}^{{x}_{l - 1}} {n}_{i} + 2 & ⋯ & {\sum }_{i = 1}^{{x}_{l}} {n}_{i}\end{matrix} ] ,$$

xi is the i^{th} bit in PRACH message to be transmitted. The UE can independently encode the N_{TTI} transmission blocks. When access is necessary, the UE initiates a call setup procedure to obtain an access allowance indication. The N_{TTI} message can then be transmitted in access preambles or access message portions, and the network can be notified.

On the network side, the network can receive the preamble of the PRACH message from the UE, and send AI to allow access to the UE via the Access Indicator Channel (AICH).

Then, on the UE side, the UE receives the AI via the AICH, and in continuous periods allowed for transmission, sequentially modulates and transmits N_{TTI} transmission blocks.

On the network side, the length of the PRACH message is set to be the length of the TTI. Then, the network executes corresponding signaling handling processes and performs other access procedure to complete the call.

One expected advantage of several embodiments of the present invention is that more messages can be transmitted using the variable-length PRACH frame structure. The increased size of the messages can ensure fast access procedures on the physical layer. As a result, call setup delay can be reduced to improve the QoS in systems, such as interactive games, emergent voice call, Push to talk Over Cellular (PoC). Another expected advantage is that transmission waste can be reduced by adjusting the length of PRACH frame structure according to the current traffic condition.

From the foregoing, it will be appreciated that specific embodiments of the invention have been described herein for purposes of illustration, but that various modifications may be made without deviating from the invention. For example, the variable-length PRACH frame structure can be implemented in other types of communication systems (e.g., GSM systems). Certain aspects of the invention described in the context of particular embodiments may be combined or eliminated in other embodiments. Accordingly, the invention is not limited except as by the appended claims.

I/We claim:

1. A variable-length PRACH frame structure, comprising a message portion having a variable length.

2. The variable-length PRACH message structure as claimed in claim 1, wherein the PRACH message portion has a length of N sub-frames (N≧1) in a WCDMA system.

3. The variable-length PRACH message structure as claimed in claim 2, wherein the length of each sub-frame is 10 ms or 20 ms.

4. The variable-length PRACH message structure as claimed in claim 1, wherein the PRACH message portion has a length of N sub-frames (N≧1) in a TD-SCDMA system.

5. The variable-length PRACH message structure as claimed in claim 4, wherein the length of each sub-frame is 5 ms.

6. A method, comprising:
determining a number of message bits (Nmax) within a maximum allowable Transmission Time Interval (TTI) of a PRACH message;
broadcasting the determined number of message bits in the cell via a system broadcast channel;
obtaining the number of the message bits within the maximum TTI using a mobile station by monitoring the system broadcast channel;
encoding, multiplexing, and modulating original message bits according to the broadcasted number of message bits; and
sending the original message bits to a base station from the mobile station.

7. The method of claim 6, wherein encoding, multiplexing, and modulating original message bits further includes:
according to current service condition, generating the original message for PRACH transmission, the original message having a length M;
calculating a required number of TTI for transmission as N_{TTI}=min (n|Nmax n≧M);
allocating the M message bits to N_{TTI} transmission blocks as evenly as possible;
independently encoding the N_{TTI} transmission blocks;
the mobile station initiates a call setup procedure to obtain an access allowance indication;
In continuous periods allowed for transmission, sequentially modulating and transmitting the NTTI transmission blocks; and
transmitting the NTTI message in access preambles or access message portions to a base station.

8. The method of claim 7, wherein the condition for access allowance is that the received access indication is 1 in a WCDMA system.

9. The method of claim 7, wherein the condition for access allowance is that a forward access channel configuration is received in a TD-SCDMA system.
